(19) United States
(12) Patent Application Publication
(10) Pub. No.: US 2024/0369711 A1
(43) Pub. Date: Nov. 7, 2024

(54) TIME-OF-FLIGHT SYSTEM AND METHOD

(71) Applicant: Sony Semiconductor Solutions Corporation, Atsugi-shi (JP)

(72) Inventors: Nicolangelo LOPEZ, Stuttgart (DE); Luc BOSSUYT, Stuttgart (DE)

(73) Assignee: Sony Semiconductor Solutions Corporation, Atsugi-shi (JP)

(21) Appl. No.: 18/776,455

(22) Filed: Jul. 18, 2024

Related U.S. Application Data
(63) Continuation-in-part of application No. PCT/EP2023/051124, filed on Jan. 18, 2023.

(30) Foreign Application Priority Data
Jan. 25, 2022 (EP) 22153245.0
Jan. 25, 2022 (EP) 22153247.6
Jan. 18, 2023 (WO) PCT/EP2023/051143

(51) Int. Cl. G01S 17/87; G01S 7/481; G01S 17/894; H04N 23/56; H04N 23/90

(52) U.S. Cl. CPC G01S 17/87; G01S 7/4815; G01S 17/894; H04N 23/56; H04N 23/90

(57) ABSTRACT

The disclosure provides a time-of-flight system that includes a set of time-of-flight cameras of a same type for covering a main field of view; wherein each time-of-flight camera of the set of time-of-flight cameras includes an imaging unit configured to image a wide subfield of view; and a set of illumination modules with predetermined fields of illumination; wherein the set of illumination modules is arranged such that the fields of illumination of the set of illumination modules illuminate the wide subfield of view; wherein the set of time-of-flight cameras is arranged such that the wide subfields of view of the set of time-of-flight cameras cover the main field of view.

### CROSS-REFERENCE TO RELATED APPLICATIONS

This application is a Continuation-In-Part of PCT Application PCT/EP2023/051124 filed Jan. 18, 2023, which claims priority to EP application Ser. No. 22/153,245.0 filed Jan. 25, 2022. The present application also claims priority to PCT Application PCT/EP2023/051143 filed Jan. 18, 2023, which claims priority to EP application Ser. No. 22/153,247.6 filed Jan. 25, 2022, the entire contents of each of which is incorporated herein by reference.

### TECHNICAL FIELD

The present disclosure generally pertains to a time-of-flight system and a method of controlling a time-of-flight system.

### TECHNICAL BACKGROUND

Known time-of-flight technology allows to capture an absolute position, a movement and a shape of environmental elements in three dimensions.

Typical time-of-flight cameras have a limited field of view and also a limited field of illumination. In order to increase the field of illumination, it is known to implement illuminators having a larger field of illumination.

Although there exist techniques for time-of-flight imaging, it is generally desirable to provide an improved technique for time-of-flight imaging.

### SUMMARY

According to a first aspect, the disclosure provides a time-of-flight system comprising a set of time-of-flight cameras of a same type for covering a main field of view; wherein each time-of-flight camera of the set of time-of-flight cameras includes an imaging unit configured to image a wide subfield of view; and a set of illumination modules with predetermined fields of illumination; wherein the set of illumination modules is arranged such that the fields of illumination of the set of illumination modules illuminate the wide subfield of view; wherein the set of time-of-flight cameras is arranged such that the wide subfields of view of the set of time-of-flight cameras cover the main field of view.

According to a second aspect, the disclosure provides a method of controlling a time-of-flight system, the time-of-flight system comprising a set of time-of-flight cameras of a same type for covering a main field of view; wherein each time-of-flight camera of the set of time-of-flight cameras includes an imaging unit configured to image a wide subfield of view; and a set of illumination modules with predetermined fields of illumination; wherein the set of illumination modules is arranged such that the fields of illumination of the set of illumination modules illuminate the wide subfield of view; wherein the set of time-of-flight cameras is arranged such that the wide subfields of view of the set of time-of-flight cameras cover the main field of view; and the method comprising controlling the set of time-of-flight cameras such that the fields of illumination of the sets of illumination modules of the set of time-of-flight cameras illuminate the main field of view according to a predetermined illumination pattern.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 shows a schematic view of a time-of-flight system according to an embodiment;

FIG. 2 shows a schematic illustration of a time-of-flight camera according to an embodiment;

FIG. 3 shows a schematic diagram of an illumination module according to an embodiment;

FIG. 4 shows a schematic diagram of a spot pattern according to an embodiment;

FIG. 5 shows a diagram of an arrangement of fields of illumination and wide sub-fields of view of a time-of-flight system according to an embodiment;

FIG. 6 shows a schematic diagram of different portions of a main field of view which are illuminated with different intensities according to an embodiment;

FIG. 7 shows a flow diagram of a method of controlling a time-of-flight system for illuminating different portions of a main field of view with different intensities according to an embodiment;

FIG. 8 shows a method of controlling a time-of-flight system based on a column pattern according to an embodiment; and

FIG. 9 shows a method of controlling a time-of-flight system based on a checker pattern according to an embodiment.

### DETAILED DESCRIPTION OF EMBODIMENTS

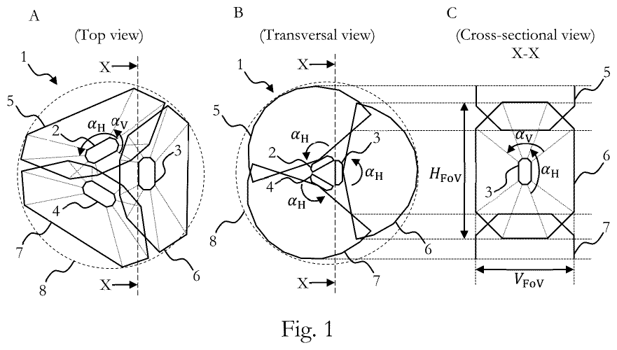

Before a detailed description of the embodiments under reference of FIG. 1 is given, general explanations are made.

As mentioned in the outset above, known time-of-flight technology allows to capture an absolute position, a movement and a shape of environmental elements in three dimensions.

Typical time-of-flight cameras have a limited field of view and also a limited field of illumination. In order to increase the field of illumination, it is known to implement illuminators having a larger field of illumination.

In some instances, a depth sensing system based on time-of-flight sensors is costly, bulky or includes movable parts, for example to provide a 360° depth sensing coverage without displacement of the depth sensing system.

In some embodiments, a time-of-flight (ToF) system with a depth sensing coverage of up to 360° without displacement of the depth sensing system is provided, which is simple, based on commercially available parts and does not rely on moving parts. The ToF system may include ToF-based sensors and active light illuminators configured for depth sensing with a wide field of view (FoV) up to 360°.

In some embodiments, a ToF system includes ToF sensing modules, and each ToF sensing module provides at least two fields of illumination (FoI) that can be activated sequentially. The ToF system may be configured such that it is possible to illuminate, for each ToF sensing module, only one FoI per time such that there is no interference due to an overlap between FoI that are being illuminated. For example, sequencing may allow an image acquisition with the full FoV of 360° in two frames without an interference due to an overlap between FoI.

Consequently, some embodiments of the present disclosure pertain to a time-of-flight system that includes a set of time-of-flight cameras of a same type for covering a main field of view; wherein each time-of-flight camera of the set of time-of-flight cameras includes an imaging unit configured to image a wide subfield of view; and a set of illumination modules with predetermined fields of illumination; wherein the set of illumination modules is arranged such that the fields of illumination of the set of illumination modules illuminate the wide subfield of view; wherein the set of time-of-flight cameras is arranged such that the wide subfields of view of the set of time-of-flight cameras cover the main field of view.

The ToF cameras of the set of ToF cameras may be configured as ToF sensing modules and may be arranged around a vertical axis such that normal directions of the ToF cameras (e.g. optical axes of their imaging units) are oriented perpendicular to the vertical axis. Alternatively, an angle between the normal directions of the ToF cameras and the vertical axis may have a value between 45° and 90° or between 70° und 90°, without limiting the disclosure in that regard.

For example, without limiting the disclosure in any way, the main FoV of the ToF system may cover any angle in an azimuthal direction, for example 116°, may cover 360° around an axis, may cover a half sphere, may cover 360° around a vertical axis and 180° in a direction of the vertical axis, or may cover a toroidal (“doughnut”) shape.

The wide sub-FoV of the ToF cameras of the set of ToF cameras may be smaller than the main FoV and may, e.g., cover 155° in a horizontal direction and 116° in a vertical direction. A combination of the wide sub-FoV may cover the main FoV. Adjacent wide sub-FoV may or may not overlap.

The ToF cameras of the set of ToF cameras may have a same type, i.e., characteristics of the ToF cameras may differ between the single ToF cameras of the set of ToF cameras (only) within fabrication tolerances. For example, the characteristics of the ToF cameras may include a horizontal and a vertical angle of the wide sub-FoV, a horizontal and a vertical illumination angle of the fields of illumination (FoI) of the single illumination modules, an illumination brightness of the single illumination modules and/or a distribution of the illumination brightness over the FoI of the single illumination modules.

The illumination modules of each ToF camera may be configured as active light illuminators. Each illumination module may provide a single FoI. The FoI of an illumination module may cover a vertical angle of 45.6° and a horizontal angle of 62.8°, for example, without limiting the present disclosure thereto. The illumination modules of ToF camera may have a same type (same characteristics), or some or all illumination modules may have different types (different characteristics). Each ToF camera may include a set of six illumination modules, without limiting the disclosure thereto.

Images and/or depth maps of the wide sub-FoV of the ToF cameras, imaged by the imaging units of the ToF cameras, may, for example, be stitched to an image or depth map that covers the main FoV. The stitching may be performed by a processor included in the ToF system or by a processor provided separate from the ToF system.

The ToF system may further include a communication interface for transmitting the images and/or depth maps of the wide sub-FoV of the ToF cameras and/or of the main FoV.

The ToF system may further include a storage, e.g. a removable storage card, for saving the images and/or depth maps of the wide sub-FoV of the ToF cameras and/or of the main FoV.

In some embodiments, for each of the set of time-of-flight cameras, the fields of illumination of the set of illumination modules are associated with respective portions of the wide subfield of view, and at least two of the illumination modules of the set of illumination modules are arranged with different orientations such that their fields of illumination illuminate the respective associated portions of the wide subfield of view.

For example, the wide sub-FoV of each ToF camera may be wider (i.e. may cover a larger horizontal and/or vertical angle) than the FoI of the single illumination modules of the ToF camera, and the illumination of the wide sub-FoV of the ToF camera may be provided in that the FoI of the single illumination modules illuminate the respective associated portions of the wide sub-FoV. For example, the associated portions of the wide sub-FoV may be distributed over the wide sub-FoV such that a combination of the FoI of the set of illumination modules of each ToF camera illuminates the wide sub-FoV of the ToF camera. Hence, the illumination modules may be smaller and/or cheaper than a single illumination module with a wide FoI that covers the wide sub-FoV.

Adjacent portions of the wide sub-FoV that are associated with the FoI of the set of illumination modules may or may not overlap. For example, the portions of the wide sub-FOV that are associated with the FoI of the set of illumination modules may overlap in a first (e.g. horizontal or vertical) direction and not overlap in a second (e.g. vertical or horizontal) direction, or may overlap in both the first and the second direction. For example, non-overlapping adjacent portions of the wide sub-FoV that are associated with the FoI of the set of illumination modules may be arranged with or without a spacing (gap) in between.

In some embodiments, at least two of the time-of-flight cameras of the set of time-of-flight cameras are arranged with different orientations such that their wide subfields of view cover the main field of view.

For example, the ToF cameras may be tilted with respect to each other or may be rotated around a common axis. In some embodiments, all ToF cameras have different orientations with respect to each other, whereas in alternative embodiments, some ToF cameras of the set of ToF cameras have a same orientation different from an orientation of another ToF camera of the set of ToF cameras. Due to the different orientations of the ToF cameras, the wide sub-FoV of the ToF cameras may cover the main FoV although the main FoV may be larger than the single wide sub-FoV of the ToF cameras.

Thus, it may be possible to deal with a mismatch in an angular space between an illumination module and (an image sensor of) an imaging unit.

In some embodiments, the wide subfields of view of at least two adjacent time-of-flight cameras of the set of time-of-flight cameras overlap.

For example, the set of ToF cameras may include three ToF cameras, without limiting the present disclosure thereto, which are rotated around a vertical axis and oriented opposite to an intersection of optical axes of the imaging units of the ToF cameras. The ToF cameras may be oriented circular so that opposite ends of the wide sub-FoV of each ToF camera overlap the wide sub-FoV of both other ToF cameras, respectively. In alternative embodiments, the main FoV may not cover a full 360° FoV.

In some embodiments, for each pair of adjacent time-of-flight cameras of the set of time-of-flight cameras, respective fields of illumination of at least one illumination module of each time-of-flight camera of the pair of adjacent time-of-flight cameras overlap.

For example, providing an overlap between FoI of adjacent ToF cameras may reduce a gap between FoI of adjacent ToF cameras. Thus, a percentage of the main FoV that is covered by at least one FoI (and, hence, for which ToF-based depth sensing may be performed) may be increased.

For example, the portions of the wide sub-FoV of the pair of adjacent ToF cameras that are associated with the respective overlapping FoI may overlap.

In some embodiments, the set of illumination modules of each of the set of time-of-flight cameras is arranged in a two-dimensional array.

The two-dimensional array may include at least two rows arranged in a first direction and at least two columns arranged in a second direction orthogonal to the first direction. For example, the array may have an equidistant spacing in any dimension. For example, the spacing may be equidistant in a planar projection, on a sphere, or on a curved surface. The ToF cameras may be arranged such that the two-dimensional arrays of illumination modules of adjacent ToF cameras are aligned in the first and/or in the second direction.

In some embodiments, each of the set of time-of-flight cameras is configured such that illumination modules of the set of illumination modules arranged in a first column of the two-dimensional array are drivable independently of illumination modules of the set of illumination modules arranged in a second column of the two-dimensional array.

For example, the illumination modules arranged in the first column may be driven with a different power than the illumination modules arranged in the second column. Thus, a first portion of the main FoV may be illuminated with a first power and a second portion of the main FoV may be illuminated with a second power different (e.g. lower) from the first power, so that the first and second portions of the main FoV may be illuminated with different intensities.

For example, illumination modules arranged in one of the first and second column may be driven (i.e. may emit light) while illumination modules arranged in the other one of the first and second column may not be driven (i.e. may not emit light). The first column of illumination modules and the second column of illumination modules may be driven alternately at different times. Thus, an interference due to an overlap between FoI of illumination modules arranged in different columns may be reduced.

In some embodiments, each of the set of time-of-flight cameras is configured such that illumination modules of the set of illumination modules arranged in an odd row of a first column of the two-dimensional array or in an even row of a second column of the two-dimensional array are drivable independently of illumination modules of the set of illumination modules arranged in an even row of the first column of the two-dimensional array or in an odd row of the second column of the two-dimensional array.

For example, the illumination modules arranged in an odd row of the first column of the two-dimensional array or in an even row of the second column of the two-dimensional array may form a first group of illumination modules, and the illumination modules arranged in an even row of the first column of the two-dimensional array or in an odd row of the second column of the two-dimensional array may form a second group of illumination modules. The first and the second group of illumination modules may be arranged in a checker pattern. The illumination modules of the first group and the illumination modules of the second group may be driven alternately at different times. Thus, an accumulation of heat due to heat dissipation may be reduced.

In some embodiments, the imaging unit of each of the set of time-of-flight cameras includes an image sensor configured to acquire a time-of-flight image; and a lens configured to collect light from the wide subfield of view onto the image sensor.

For example, the image sensor may be configured as a time-of-flight (ToF) sensor and may include one or more photoelectric conversion elements, e.g. photodiodes, that convert(s) incident light into an electrical signal. The one or more photoelectrical conversion elements may be arranged in one or more pixels.

For example, the lens may be arranged at a focal distance before the image sensor and may focus light incident from the wide sub-FoV of the respective ToF camera onto the photoelectric conversion element(s) of the image sensor.

An optical axis of the imaging unit may be orthogonal to an imaging plane of the image sensor, and may intersect a center (e.g., an axis of rotational symmetry) of the image sensor and/or of the lens.

In some embodiments, each of the set of illumination modules of each of the set of time-of-flight cameras is configured to emit a spot pattern into its field of illumination.

For example, the spot pattern may include a plurality of two-dimensionally arranged spots. The plurality of spots may be arranged in a hexagonal grid structure, in a simple cubic grid structure, in a face-centered cubic grid structure, or the like. The spot pattern may be generated by one or more vertical-cavity surface-emitting lasers (VCSEL) and/or may be shaped by one or more diffractive optical elements (DOE).

Emitting a spot pattern instead of a homogeneous light allows, in some embodiments, to concentrate a maximal admissible light intensity on the spots of the spot pattern while ensuring eye safety, and to perform depth sensing over a wider distance with a higher signal-to-noise ratio (SNR) than with homogeneous light. For example, the spot pattern may conform to the laser class 1 specification. For example, illuminating the main FoV with a spot pattern may allow a three-dimensional (3D) mapping of an interior of a building at distances of up to 15 or 20 meters, without limiting the scope of the present disclosure in any way.

Some embodiments pertain to a method of controlling a time-of-flight system, wherein the time-of-flight system includes a set of time-of-flight cameras of a same type for covering a main field of view; wherein each time-of-flight camera of the set of time-of-flight cameras includes: an imaging unit configured to image a wide subfield of view; and a set of illumination modules with predetermined fields of illumination; wherein the set of illumination modules is arranged such that the fields of illumination of the set of illumination modules illuminate the wide subfield of view; wherein the set of time-of-flight cameras is arranged such that the wide subfields of view of the set of time-of-flight cameras cover the main field of view; and wherein the method includes controlling the set of time-of-flight cameras such that the fields of illumination of the sets of illumination modules of the set of time-of-flight cameras illuminate the main field of view according to a predetermined illumination pattern.

For example, the method may be a method for controlling a ToF system according to any configuration as described above and it may be implemented by a circuitry (control) of the ToF system, which may have, e.g., a processor, an imaging unit, integrated circuits, application specific processors, etc.

For example, the predetermined illumination pattern may represent an instruction to cause one or more specific illumination modules of the sets of illumination modules of the ToF cameras to emit or to not emit light, or to emit light with a predetermined intensity of several predetermined intensities.

In some embodiments, the predetermined illumination pattern is based on at least one of a temporal and a spatial criterion for driving the sets of illumination modules of the set of time-of-flight cameras.

For example, the predetermined illumination pattern may represent an instruction to cause one or more specific illumination modules of the sets of illumination modules of the set of ToF cameras to emit light at a first point of time and not to emit light at a second point of time different from (e.g. earlier or later than) the first point of time (temporal criterion).

For example, the predetermined illumination pattern may represent an instruction to cause one or more specific illumination modules of the set of illumination modules of the set of ToF cameras to emit light or to not emit light, or to emit light with a predetermined intensity of several predetermined intensities, based on a position of the specific illumination module(s) (or of their FoI).

In some embodiments, the predetermined illumination pattern represents an instruction to drive adjacent illumination modules of the sets of illumination modules of the set of time-of-flight cameras in a temporally alternating manner.

For example, at a first time interval, a first FoI of two adjacent FoI may illuminate its associated portions of the corresponding wide sub-FoV and a second FoI of the two adjacent FoI may not illuminate its associated portion of the corresponding wide sub-FoV, and at a second time interval, the first FoI may not illuminate its associated portion of the corresponding wide sub-FoV and the second FoI may illuminate its associated portion of the corresponding wide sub-FoV. Hence, the two adjacent FoI may illuminate their respective associated portions of the corresponding wide sub-FoV in a temporally alternating manner. The first and the second time interval may be subsequent time intervals and may or may not overlap. The two adjacent FoI may be provided by illumination modules included in a same ToF camera or in different (e.g. adjacent) ToF cameras.

For example, portions of the corresponding wide sub-FoV that are associated with the respective adjacent FoI may be illuminated sequentially in different time frames or subframes for avoiding an interference due to an overlap between FoI.

For example, illumination modules arranged in a left column may be driven (activated) in a first time frame or subframe, and illumination modules arranged in a right column may be driven (activated) in a second time frame or subframe.

The image sensors of the imaging units of the ToF cameras may be driven with only a partial region of interest (ROI) for each illumination sequence; for example, in each time frame or subframe, the partial ROI may correspond to portions of the corresponding wide sub-FoV that are illuminated in the respective time frame or subframe.

In some embodiments, the predetermined illumination pattern represents an instruction to illuminate a first portion of the main field of view with a first intensity and illuminate a second portion of the main field of view with a second intensity lower than the first intensity. For example, the first portion of the main FoV may correspond to a direction in which depth sensing is required over a wider distance than in a direction that corresponds to the second portion, e.g. because objects to be sensed are further apart in the direction corresponding to the first portion of the main FoV than in the direction corresponding to the second portion of the main FoV. Illuminating the second portion of the main FoV with a lower intensity may reduce a consumption of electrical energy.

In some embodiments, the first and the second intensity differ in at least one of a power of driving corresponding illumination modules of the sets of illumination modules of the time-of-flight cameras and a density of spots emitted by the corresponding illumination modules of the sets of illumination modules of the time-of-flight cameras.

For example, reducing a power of driving the corresponding illumination modules may allow saving electrical energy without affecting a depth sensing resolution, and reducing a density of spots emitted by the corresponding illumination modules may allow saving electrical energy without affecting a depth sensing range.

In some embodiments, the second portion of the main field of view includes at least one of a portion above the first portion of the main field of view in a vertical direction and a portion below the first portion of the main field of view in a vertical direction.

For example, when performing depth sensing of an interior of a building, the portion above the first portion of the main FoV in the vertical direction may correspond to a ceiling, the portion below the first portion of the main FoV in the vertical direction may correspond to a floor, and the first portion of the FoV may correspond to walls, doors, persons, furniture and other objects in a room or building. The ceiling and/or the floor may be closer to the ToF system than the walls and objects so that depth sensing of the ceiling and/or the floor may require a lower depth sensing range. For the ceiling and/or the floor, less details may be required than for the walls and objects so that depth sensing of the ceiling and/or the floor may require a lower depth sensing resolution.

In some embodiments, the predetermined illumination pattern represents an instruction to operate the sets of illumination modules of the set of time-of-flight cameras such that an interference due to an overlap between adjacent fields of illumination is reduced.

An interference between FoI due to an overlap of the FoI may impede depth sensing for a portion of the corresponding wide sub-FoV in which the FoI overlap because an assignment of incident light to a specific illumination module may not be possible. For example, an interference of overlapping FoI of adjacent illumination modules may occur if the adjacent illumination modules are driven in a same time interval. In such a case, the interference of overlapping FoI may be avoided by driving the corresponding adjacent illumination modules in different time intervals instead of in a same time interval.

In some embodiments, the predetermined illumination pattern represents an instruction to drive, during a first time interval, illumination modules, of the sets of illumination modules of the set of time-of-flight cameras, that are arranged in a first column, and during a second time interval, illumination modules, of the sets of illumination modules of the set of time-of-flight cameras, that are arranged in a second column adjacent to the first column.

For example, the sets of illumination modules may be arranged such that FoI of illumination modules arranged in adjacent rows of a same column do not overlap, or their overlap may be negligible, but that FoI of illumination modules arranged in a same row of adjacent columns overlap, at least in a predetermined distance range. Then, for example, an interference due to an overlap between adjacent FoI may be avoided by driving the sets of illumination modules in a manner temporally alternating between adjacent columns.

For example, the arrangement of the sets of illumination modules of the set of ToF cameras may be aligned between adjacent ToF cameras, and driving illumination modules arranged in the first or second column may include driving the illumination modules arranged in the corresponding column for all ToF cameras whose illumination modules are arranged in alignment.

In some embodiments, however, the set of illumination modules is arranged such that FoI of illumination modules arranged in a same row of adjacent columns do not overlap, or their overlap is negligible. Then, for example, the predetermined illumination pattern may represent an instruction to drive, during a first time interval, illumination modules, of the sets of illumination modules of the set of ToF cameras, that are arranged in a first row, and during a second time interval, illumination modules, of the sets of illumination modules of the set of ToF cameras, that are arranged in a second row adjacent to the first row.

In some embodiments, the predetermined illumination pattern represents an instruction to operate the sets of illumination modules of the set of time-of-flight cameras such that a heat accumulation between adjacent illumination modules of the sets of illumination modules of the set of time-of-flight cameras due to heat dissipation is reduced.

For example, an electrical current flowing in an illumination module while the illumination module emits light (i.e. is driven) may cause a temperature of the illumination module and/or its surroundings to increase, and a too high temperature may cause temporal and/or irreversible malfunction of the illumination module. An illumination module and/or its surroundings may cool down while the illumination module does not emit light (i.e. is not driven). Therefore, for example, the predetermined illumination pattern may represent instructions to not drive adjacent illumination modules during a same time interval but to drive adjacent illumination modules in a temporally alternating manner.

In some embodiments, the predetermined illumination pattern represents an instruction to drive, during a first time interval, illumination modules, of the sets of illumination modules of the time-of-flight cameras, that are arranged in an odd row of an odd column or in an even row of an even column, and, during a second time interval, illumination modules, of the sets of illumination modules of the time-of-flight cameras, that are arranged in an even row of the odd column or in an odd row of the even column.

Thus, the predetermined illumination pattern may be visualized as, e.g., a checker pattern. For example, the arrangement of the sets of illumination modules may be aligned between adjacent ToF cameras, and driving the sets of illumination modules according to a checker pattern may include driving the illumination modules accordingly for all ToF cameras whose illumination modules are arranged in alignment.

For example, controlling the sets of illumination modules according to this pattern may allow that, when an illumination module is driven (i.e. emits light), none of the illumination modules in its four-connected neighborhood is driven, so that a heat in the driven illumination module may be dissipated to four sides, and a heat accumulation in the driven illumination module may be reduced or avoided.

In some embodiments, the set of illumination modules of each ToF camera or the illumination modules of the sets of illumination modules of all ToF cameras are divided into two groups, wherein the first of the two groups is driven in odd time intervals of a sequence of time intervals and the second of the two groups is driven in even time intervals of the sequence of time intervals. By driving two groups of illumination modules, control circuitry may occupy less space and it may be possible to reduce a size of the ToF cameras and/or of the ToF system with respect to embodiments in which more than two groups of illumination modules are driven.

In some embodiments, however, e.g. if enough space for corresponding control circuitry is available, the set of illumination modules of each ToF camera or the illumination modules of the sets of illumination modules of all ToF cameras may be divided into more than two (e.g. three, four or more) groups of illumination modules which may be driven subsequently in subsequent time intervals. The more than two groups of illumination modules may be disjoint or may intersect. For example, controlling more than two groups of illumination modules may allow that, when an illumination module is driven, less than four (i.e. three, two, one or zero) illumination modules in its eight-connected neighborhood are driven, so that an interference due to an overlap between adjacent FoI may further be avoided and/or an accumulation of heat due to heat dissipation may further be reduced or avoided.

The methods as described herein are also implemented in some embodiments as a computer program causing a computer and/or a processor to perform the method in any configuration described above, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is provided a schematic view of a time-of-flight (ToF) system 1 according to an embodiment. The ToF system 1 includes three ToF cameras 2 to 4 that are configured to image respective wide subfields of view (sub-FoV) 5 to 7.

Part A of FIG. 1 shows the ToF system 1 from a top view, which is a projection of the ToF system 1 in a horizontal plane. Part B of FIG. 1 shows the ToF system 1 in a transversal view, which is a cross-section in a horizontal direction. Part C of FIG. 1 shows the ToF system 1 in a cross-sectional view, which is a cross-section in a vertical direction at a position indicated by a vertical dashed line from X to X in Parts A and B.

Each of the wide sub-FoV 5 to 7 covers a horizontal viewing angle α_{H} and a vertical viewing angle α_{V}. The ToF cameras 2 to 4 are arranged around a vertical axis such that their wide sub-FoV 5 to 7 overlap with their respective adjacent wide sub-FoV 5 to 7 in a horizontal direction. Thus, a combination of the wide sub-FoV 5 to 7 covers a main FoV 8 of the ToF system 1. The main FoV 8 of the ToF system 1 covers 360°. In the cross-section X-X, the wide sub-FoV 6 has a horizontal extent of H_{FoV} and a vertical extent of V_{FoV}. The ToF cameras 2 to 4 are oriented such that their normal directions, i.e. an optical axis of their imaging units, is perpendicular to the vertical axis. The main FoV 8 of the ToF system 1 covers 360° in a horizontal direction and, because the ToF cameras 2 to 4 are oriented within a same horizontal plane, covers ay in a vertical direction.

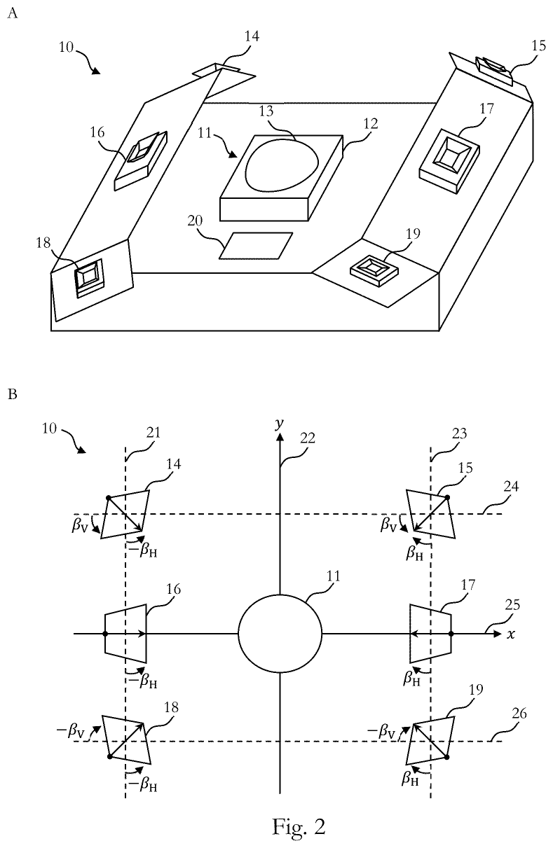

FIG. 2 shows a schematic illustration of a ToF camera 10 according to an embodiment. The ToF camera 10 is an example for the ToF cameras 2 to 4 of FIG. 1.

Part A of FIG. 2 shows the ToF camera 10 in a perspective view.

The ToF camera 10 includes an imaging unit 11 configured to image a wide sub-FoV such as the wide sub-FoV 5 to 7 of FIG. 1. The imaging unit 11 includes an image sensor 12 configured as ToF sensor for acquiring a ToF image and a lens 13 configured to collect light from the wide sub-FoV onto the image sensor 12.

The ToF camera 10 further includes illumination modules 14 to 19 configured to emit FoI that illuminate the wide sub-FoV and a control 20 that includes circuitry configured to control the image sensor 12 and the illumination modules 14 to 19.

Part B of FIG. 2 shows a block diagram of the ToF camera 10. The imaging unit 11 and the illumination modules 14 to 19 are arranged in a two-dimensional array with columns oriented in a vertical direction indicated by a y-axis and with rows oriented in a horizontal direction indicated by an x-axis. The illumination modules 14, 16 and 18 are arranged in a first column 21, the imaging unit 11 is arranged in a second column 22 that coincides with the y-axis, and the illumination modules 15, 17 and 19 are arranged in a third column 23. The illumination modules 14 and 15 are arranged in a first row 24, the imaging unit 11 as well as the illumination modules 16 and 17 are arranged in a second row 25 that coincides with the x-axis, and the illumination modules 18 and 19 are arranged in a third row 26.

The illumination modules 14 to 19 are tilted with respect to an x-y plane spanned by the x-axis and the y-axis. A tilt of each illumination module 14 to 19 is indicated by an arrow that points from a lowest portion of the illumination module 14 to 19, below the x-y plane, to a highest portion of the illumination module 14 to 19, above the x-y plane. The illumination module 14 is tilted by a vertical tilt angle β_{V} in the vertical direction and by a horizontal tilt angle −β_{H} in the horizontal direction. The illumination module 15 is tilted by a vertical tilt angle β_{V} in the vertical direction and by a horizontal tilt angle β_{H} in the horizontal direction. The illumination module 16 is tilted by a horizontal tilt angle −β_{H} in the horizontal direction. The illumination module 17 is tilted by a horizontal tilt angle β_{H} in the horizontal direction. The illumination module 18 is tilted by a vertical tilt angle −β_{V} in the vertical direction and by a horizontal tilt angle −β_{H} in the horizontal direction. The illumination module 19 is tilted by a vertical tilt angle-By in the vertical direction and by a horizontal tilt angle β_{H} in the horizontal direction. Thus, each illumination module 14 to 19 is tilted such that its FoI illuminates an associated portion of the wide sub-FoV of the ToF camera 10.

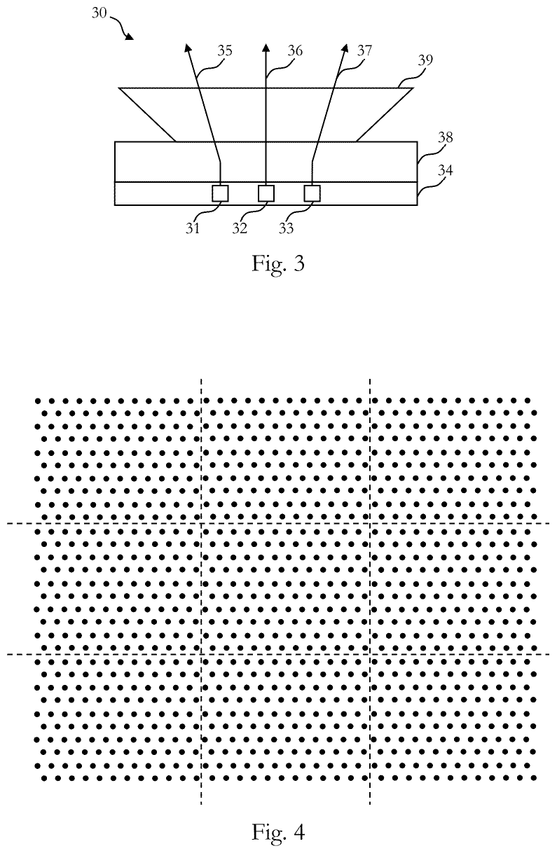

FIG. 3 shows a schematic diagram of an illumination module 30 according to an embodiment.

The illumination module 30 is an example for the illumination modules 14 to 19 of FIG. 2. Therefore, the illumination modules 14 to 19 have same characteristics. The illumination module 30 is configured as an active illuminator.

The illumination module 30 includes a light generation layer 34. The light generation layer 34 includes vertical-cavity surface-emitting lasers (VCSELs) 31 to 33 and circuitry (not depicted) for driving the VCSELs 31 to 33.

The VCSELs 31 to 33 emit respective laser beams 35 to 37. The emitted laser beams 35 to 37 pass a light manipulation layer 38. The light manipulation layer 38 includes means for manipulating the beams, including lenses for directing the laser beams 35 to 37, and diffractive optical elements (DOE) for splitting and shaping the laser beams 35 to 37.

After the light manipulation layer 38, the laser beams 35 to 37 pass through a shade 39 to suppress stray light. Then, the laser beams 35 to 37 leave the illumination module 30 into a scene.

In the embodiment of FIG. 3, the laser beams 35 to 37 emitted by the illumination module 30 provide a single transmitted FoI which covers a horizontal angle of 62.8° and a vertical angle of 45.6°, without limiting the present disclosure thereto.

FIG. 4 shows a schematic diagram of a spot pattern according to an embodiment. Each spot in FIG. 4 represents one laser beam emitted by an illumination module, for example by the illumination module 30. In a horizontal direction of FIG. 4, a horizontal angle of a FoI is plotted, and in a vertical direction of FIG. 4, a vertical angle of the FoI is plotted. The spots are arranged in a two-dimensional hexagonal grid. However, the present disclosure is not limited thereto.

The spot pattern of FIG. 4 includes spots from a set of illumination modules 30, as indicated by dashed lines. Each portion of the spot pattern limited by dashed lines is emitted by another illumination module 30. Each FoI of each respective illumination module 30 contributes an associated portion of the spot pattern and, thus, illuminates an associated portion of a wide sub-FoV. Therefore, the respective FoI of the set of illumination modules 30 illuminate the wide sub-FoV.

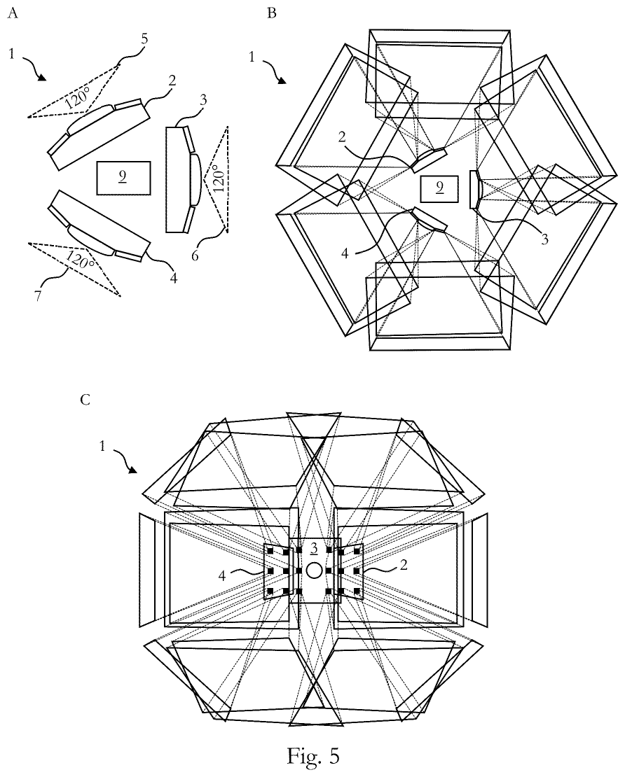

FIG. 5 illustrates a diagram of an arrangement of FoI and wide sub-FoV of a ToF system 1 according to an embodiment.

In part A of FIG. 5, the ToF system 1 of FIG. 1 is shown in a top view together with the wide sub-FoV 5 to 7 of its ToF cameras 2 to 4. The ToF cameras 2 to 4 of the ToF system 1 are arranged around a vertical axis such that each of their wide sub-FoV 5 to 7 covers 120° in a horizontal direction. The ToF system 1 further includes a control 9 that includes an integrated circuit and that is configured to control the ToF cameras 2 to 4 and output depth sensing information determined by the ToF system 1.

In part B of FIG. 5, the ToF system 1 is shown in a top view together with the FoI of its ToF cameras 2 to 4. Each ToF camera 2 to 4 includes two columns of three illumination modules. The columns are oriented perpendicular to the image plane. Thus, the single illumination modules of each column are not distinguishable in part B of FIG. 5, but their corresponding FoI can be distinguished due to their different vertical orientations.

In part C of FIG. 5, the ToF system 1 is shown in a side view together with the FoI of its ToF cameras 2 to 4, with a perspective from a right direction of the parts A and B of FIG. 5. In the side view, the single illumination modules (black squares) arranged in vertical columns of three illumination modules are clearly distinguishable. The different horizontal and vertical orientations of the FoI are clearly visible.

Thus, the ToF cameras 2 to 4 of the ToF system 1 are arranged such that a combination of their respective wide sub-FoV 5 to 7 cover the main FoV 8 of the ToF system 1, which covers 360°, and that a combination of the FoI of the illumination modules of the ToF cameras 2 to 4 illuminates the respective wide sub-FoV 5 to 7, i.e. the FoI of the illumination modules of the ToF cameras 2 to 4 illuminate the main FoV 8 of the ToF system 1.

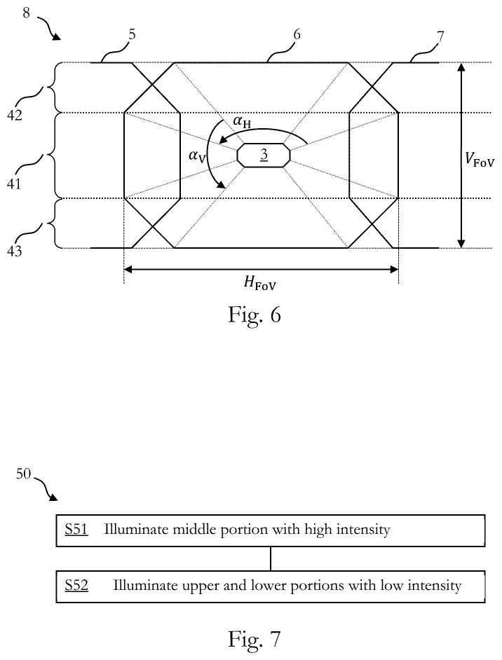

In FIG. 6, a schematic diagram of different portions 41 to 43 of the main FoV 8 are shown which are illuminated with different intensities according to an embodiment.

The wide sub-FoV 6 of the ToF camera 3 of the ToF system 1 of FIGS. 1 and 5 is shown in a center of FIG. 6. The wide sub-FoV 6 covers a horizontal viewing angle α_{H} and a vertical viewing angle α_{V}, and extends to H_{FoV} in a horizontal direction and to V_{FoV} in a vertical direction. Parts of the wide sub-FoV 5 and 7 of the ToF cameras 2 and 4, respectively, are also shown.

The wide sub-FoV 5 to 7 (and, thus, the main FoV 8) are vertically divided into three portions 41 to 43, which include a middle portion 41, an upper portion 42 and a lower portion 43. The portions 41 to 43 are illumination areas that can be illuminated with different intensities. The ToF system 1 is configured such that the illumination intensities of the portions 41 to 43 of the main FoV 8 can be adjusted by driving the corresponding illumination modules with a different power and by emitting a different spot density from the illumination modules.

In an indoor application, the middle portion 41 of the main FoV 8 corresponds to a position of middle height in which walls, doors, persons, furniture and other objects are located, the upper portion 42 corresponds to a higher position above the middle portion 41, at which a ceiling is located, and the lower portion 43 corresponds to a lower position below the middle portion 41 at which a floor is located. The ToF system 1 is configured to illuminate the upper and lower portions 42 and 43, which correspond to a ceiling and a floor, respectively, with a lower intensity than the middle portion 41, and to illuminate the middle portion 41 with a higher intensity than the upper and lower portions 42 and 43. Thus, a consumption of electrical energy can be reduced by illuminating the upper and lower portions 42 and 43, for which a lower depth sensing distance and/or depth sensing precision is required, with a lower intensity, while illuminating the middle portion 41 with a higher intensity for maintaining an optimal depth sensing distance and/or an optimal depth sensing precision.

FIG. 7 shows a flow diagram of a method 50 of controlling a ToF system 1 for illuminating different portions 41 to 43 of a main FoV 8 with different intensities according to an embodiment. The method 50 is executed by the ToF system 1 of FIGS. 1 and 5 and allows the ToF system 1 to illuminate the middle portion 41 of the main FoV 8 with a high intensity and to illuminate the upper and lower portions 42 and 43 of the main FoV 8 with a low intensity that is lower than the high intensity.

At S51, corresponding FoI of the ToF system 1 illuminate the middle portion 41 of the main FoV 8 with a high intensity. The ToF system 1 provides the high intensity by driving the illumination modules that provide the corresponding FoI with a high electrical power and by emitting a high spot density into the corresponding FoI.

At S52, corresponding FoI of the ToF system 1 illuminate the upper and lower portions 42 and 43 of the main FoV 8 with a low intensity that is lower than the high intensity. The ToF system 1 provides the low intensity by driving the illumination modules that provide the corresponding FoI with a low electrical power, that is lower than the high electrical power, and by emitting a low spot density, which is lower than the high spot density, into the corresponding FoI.

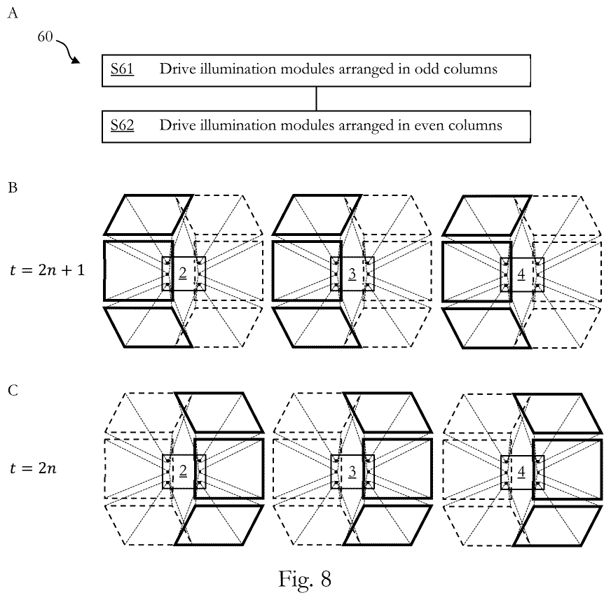

FIG. 8 illustrates a method 60 of controlling a ToF system 1 based on a column pattern according to an embodiment. The method 60 is performed by the ToF system 1 of FIGS. 1 and 5, more precisely by the control 9 of the ToF system 1, and avoids (or, at least, reduces) an interference due to an overlap between FoI of adjacent columns of illumination modules.

Part A of FIG. 8 shows a flow diagram of the method 60. The illumination modules of the ToF cameras 2 to 4 are driven sequentially according to a column pattern in a sequence of time intervals.

At S61, the control 9 causes illumination modules that are arranged in odd columns to be driven, i.e. to emit a FoI, in a first time interval, which is an odd time interval in the sequence of time intervals.

At S62, the control 9 causes illumination modules that are arranged in even columns to be driven, i.e. to emit a FoI, in a second time interval different from the first time interval, which is an even time interval in the sequence of time intervals.

Part B of FIG. 8 illustrates the ToF cameras 2 to 4 in a side view in the first time interval, which corresponds to S61 of the method 60. Note that the cameras 2 to 4 are arranged in a circular arrangement such that the ToF cameras 2 and 4 are adjacent. The first time interval is an odd time interval in the sequence of time intervals. Thus, a number t of the first time interval is odd (t=2n+1 for a non-negative integer n). Illumination modules in odd columns are driven (illustrated by solid lines of their FoI) and illumination modules in even columns are not driven (illustrated by dashed lines of their FoI).

Part C of FIG. 8 illustrates the ToF cameras 2 to 4 in a side view in the second time interval, which corresponds to S62 of the method 60. The second time interval is an even time interval in the sequence of time intervals. Thus, a number t of the second time interval is even (t=2n for a non-negative integer n). Illumination modules arranged in even columns are driven (illustrated by solid lines of their FoI) and illumination modules arranged in odd columns are not driven (illustrated by dashed lines of their FoI).

As illustrated in parts B and C of FIG. 8, FoI of a same column of illumination modules do not overlap, whereas some pairs of FoI of adjacent columns of illumination modules overlap. Hence, an interference due to an overlap between FoI of adjacent columns of illumination modules is avoided by the method 60 of driving the illumination modules according a column pattern.

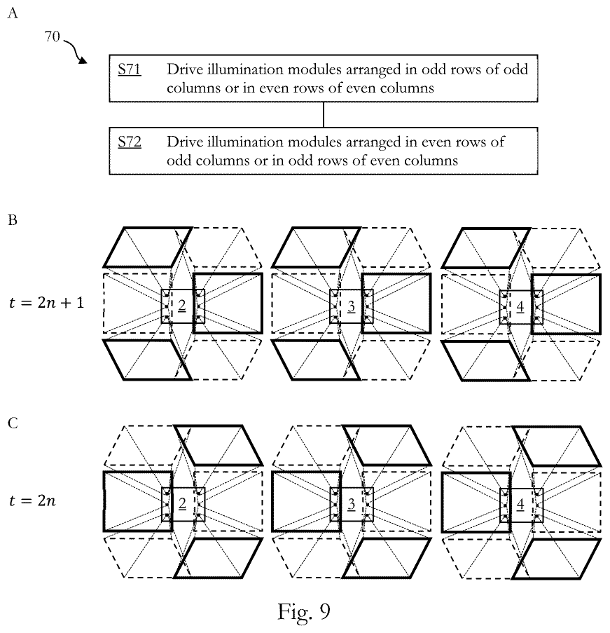

FIG. 9 illustrates a method 70 of controlling a ToF system 1 based on a checker pattern according to an embodiment. The method 70 is performed by the ToF system 1 of FIGS. 1 and 5, more precisely by the control 9 of the ToF system 1, and reduces an accumulation of heat due to heat dissipation of adjacent illumination modules.

Part A of FIG. 9 shows a flow diagram of the method 70. The illumination modules of the ToF cameras 2 to 4 are driven sequentially according to a checker pattern in a sequence of time intervals.

At S71, the control 9 causes illumination modules that are arranged in odd rows of odd columns or in even rows of even columns to be driven, i.e. to emit a FoI, in a first time interval, which is an odd time interval in the sequence of time intervals.

At S72, the control 9 causes illumination modules that are arranged in even rows of odd columns or in odd rows of even columns to be driven, i.e. to emit a FoI, in a second time interval different from the first time interval, which is an even time interval in the sequence of time intervals.

Part B of FIG. 9 illustrates the ToF cameras 2 to 4 in a side view in the first time interval, which corresponds to S71 of the method 70. Note that the cameras 2 to 4 are arranged in a circular arrangement such that the ToF cameras 2 and 4 are adjacent. The first time interval is an odd time interval in the sequence of time intervals. Thus, a number t of the first time interval is odd (t=2n+1 for a non-negative integer n). Illumination modules in odd rows of odd columns or in even rows of even columns are driven (illustrated by solid lines of their FoI) and illumination modules in even rows of odd columns or in odd rows of even columns are not driven (illustrated by dashed lines of their FoI).

Part C of FIG. 9 illustrates the ToF cameras 2 to 4 in a side view in the second time interval, which corresponds to S72 of the method 70. The second time interval is an even time interval in the sequence of time intervals. Thus, a number t of the second time interval is even (t=2n for a non-negative integer n). Illumination modules arranged in even rows of odd columns or in odd rows of even columns are driven (illustrated by solid lines of their FoI) and illumination modules arranged in odd rows of odd columns or in even rows of even columns are not driven (illustrated by dashed lines of their FoI).

As illustrated in parts B and C of FIG. 9, not more than one illumination module per four-connected neighborhood of illumination modules is driven within each time interval. Hence, heat caused by driving an illumination module can be dissipated to four sides of the illumination modules that are driven, and an accumulation of heat in the illumination modules is reduced by the method 70 of driving the illumination modules according a checker pattern.

The single illumination modules (active light illuminators) of each ToF camera of an ToF system according to an embodiment may be tilted by different angles.

In some embodiments, the illumination modules of each ToF camera in a ToF system are arranged in two columns and are tilted so that FoI of adjacent illumination modules arranged in a first row and in a third row overlap, a gap is provided between FoI of adjacent illumination modules arranged in a same column, and the illumination modules are driven based on a column pattern, as discussed above under reference of FIG. 8. In this configuration, the ToF system may be simpler and easier to manage, but a temperature may rise higher in each column due to heat dissipation, a risk of interference due to an overlap of adjacent FoI may be increased (skip pulse issue), and/or a power demand on each side of a direct current (DC)-to-DC converter that supplies both columns of illumination modules may be increased.

In some embodiments, the illumination modules of each ToF camera in a ToF system are arranged in two columns, are tilted so that FoI of adjacent illumination modules arranged in different columns do not overlap, and that FoI of adjacent illumination modules arranged in a same column overlap, and the illumination modules are driven based on a checker pattern, as discussed above under reference of FIG. 9. In this configuration, a risk of interference due to an overlap of FoI may be reduced (skip pulse issue) and a power demand may be more balanced between the two columns of illumination modules, but image processing (stitching, calibration, etc.) of an acquired ToF image may be more complicated, and a risk of an interference due to an overlap of an FoI of a middle illumination module with adjacent FoI of illumination modules of the same column may be increased.

In some embodiments, an effect of driving the illumination modules sequentially (at a level of the ToF system, which includes several ToF cameras) is dual: An interference where adjacent FoI of different ToF cameras overlap may be avoided, and a stitching of overlapping adjacent FoI of different ToF cameras may be facilitated.

It should be recognized that the embodiments describe methods with an exemplary ordering of method steps. The specific ordering of method steps is however given for illustrative purposes only and should not be construed as binding. For example, the ordering of S51 and S52 in the embodiment of FIG. 7 may be exchanged. Also, the ordering of S61 and S62 in the embodiment of FIG. 8 may be exchanged. Further, also the ordering of S71 and S72 in the embodiment of FIG. 9 may be exchanged. Other changes of the ordering of method steps may be apparent to the skilled person.

Please note that the distinction between the control 9 of FIG. 5 of a ToF system 1 and the control 20 of FIG. 2 of each ToF camera 2 to 4 is only made for illustration purposes and that the present disclosure is not limited to any specific division of functions in specific units. For example, the function of the control 20 of one, more or all ToF cameras 2 to 4 could be provided by the control 9 of the ToF system 1. For instance, the control 9 of FIG. 5 and/or the control 20 of FIG. 2 could be implemented by a respective programmed processor, field programmable gate array (FPGA) and the like.

The method 50 of FIG. 7, the method 60 of FIG. 8 and the method 70 of FIG. 9 can also be implemented as a computer program causing a computer and/or a processor, such as the control 9 and/or the controls 20 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A time-of-flight system comprising:
   a set of time-of-flight cameras of a same type for covering a main field of view;
   wherein each time-of-flight camera of the set of time-of-flight cameras includes:
      an imaging unit configured to image a wide subfield of view; and
      a set of illumination modules with predetermined fields of illumination;
      wherein the set of illumination modules is arranged such that the fields of illumination of the set of illumination modules illuminate the wide subfield of view;
   wherein the set of time-of-flight cameras is arranged such that the wide subfields of view of the set of time-of-flight cameras cover the main field of view.
(2) The time-of-flight system of (1), wherein, for each of the set of time-of-flight cameras,
   the fields of illumination of the set of illumination modules are associated with respective portions of the wide subfield of view, and
   at least two of the illumination modules of the set of illumination modules are arranged with different orientations such that their fields of illumination illuminate the respective associated portions of the wide subfield of view.
(3) The time-of-flight system of (2), wherein at least two of the time-of-flight cameras of the set of time-of-flight cameras are arranged with different orientations such that their wide subfields of view cover the main field of view.
(4) The time-of-flight system of (3), wherein the wide subfields of view of at least two adjacent time-of-flight cameras of the set of time-of-flight cameras overlap.
(5) The time-of-flight system of any one of (1) to (4),
   wherein, for each pair of adjacent time-of-flight cameras of the set of time-of-flight cameras, respective fields of illumination of at least one illumination module of each time-of-flight camera of the pair of adjacent time-of-flight cameras overlap.
(6) The time-of-flight system of (5), wherein the set of illumination modules of each of the set of time-of-flight cameras is arranged in a two-dimensional array.
(7) The time-of-flight system of (6), wherein each of the set of time-of-flight cameras is configured such that illumination modules of the set of illumination modules arranged in a first column of the two-dimensional array are drivable independently of illumination modules of the set of illumination modules arranged in a second column of the two-dimensional array.
(8) The time-of-flight system of (6), wherein each of the set of time-of-flight cameras is configured such that illumination modules of the set of illumination modules arranged in an odd row of a first column of the two-dimensional array or in an even row of a second column of the two-dimensional array are drivable independently of illumination modules of the set of illumination modules arranged in an even row of the first column of the two-dimensional array or in an odd row of the second column of the two-dimensional array.
(9) The time-of-flight system of any one of (1) to (8), wherein the imaging unit of each of the set of time-of-flight cameras includes:
   an image sensor configured to acquire a time-of-flight image; and
   a lens configured to collect light from the wide subfield of view onto the image sensor.
(10) The time-of-flight system of any one of (1) to (9), wherein each of the set of illumination modules of each of the set of time-of-flight cameras is configured to emit a spot pattern into its field of illumination.
(11) A method of controlling a time-of-flight system,
   the time-of-flight system comprising:
      a set of time-of-flight cameras of a same type for covering a main field of view;
      wherein each time-of-flight camera of the set of time-of-flight cameras includes:
         an imaging unit configured to image a wide subfield of view; and
         a set of illumination modules with predetermined fields of illumination;
         wherein the set of illumination modules is arranged such that the fields of illumination of the set of illumination modules illuminate the wide subfield of view;
      wherein the set of time-of-flight cameras is arranged such that the wide subfields of view of the set of time-of-flight cameras cover the main field of view; and
   the method comprising:
      controlling the set of time-of-flight cameras such that the fields of illumination of the sets of illumination modules of the set of time-of-flight cameras illuminate the main field of view according to a predetermined illumination pattern.
(12) The method of (11), wherein the predetermined illumination pattern is based on at least one of a temporal and a spatial criterion for driving the sets of illumination modules of the set of time-of-flight cameras.
(13) The method of (11) or (12), wherein the predetermined illumination pattern represents an instruction to drive adjacent illumination modules of the sets of illumination modules of the set of time-of-flight cameras in a temporally alternating manner.
(14) The method of any one of (11) to (13), wherein the predetermined illumination pattern represents an instruction to illuminate a first portion of the main field of view with a first intensity and illuminate a second portion of the main field of view with a second intensity lower than the first intensity.
(15) The method of (14), wherein the first and the second intensity differ in at least one of a power of driving corresponding illumination modules of the sets of illumination modules of the time-of-flight cameras and a density of spots emitted by the corresponding illumination modules of the sets of illumination modules of the time-of-flight cameras.
(16) The method of (14) or (15), wherein the second portion of the main field of view includes at least one of a portion above the first portion of the main field of view in a vertical direction and a portion below the first portion of the main field of view in a vertical direction.
(17) The method of any one of (11) to (16), wherein the predetermined illumination pattern represents an instruction to operate the sets of illumination modules of the set of time-of-flight cameras such that an interference due to an overlap between adjacent fields of illumination is reduced.
(18) The method of (17), wherein the predetermined illumination pattern represents an instruction to drive,
   during a first time interval, illumination modules, of the sets of illumination modules of the set of time-of-flight cameras, that are arranged in a first column, and
   during a second time interval, illumination modules, of the sets of illumination modules of the set of time-of-flight cameras, that are arranged in a second column adjacent to the first column.
(19) The method of any one of (11) to (13), wherein the predetermined illumination pattern represents an instruction to operate the sets of illumination modules of the set of time-of-flight cameras such that a heat accumulation between adjacent illumination modules of the sets of illumination modules of the set of time-of-flight cameras due to heat dissipation is reduced.
(20) The method of (19), wherein the predetermined illumination pattern represents an instruction to drive,
   during a first time interval, illumination modules, of the sets of illumination modules of the time-of-flight cameras, that are arranged in an odd row of an odd column or in an even row of an even column, and,
   during a second time interval, illumination modules, of the sets of illumination modules of the time-of-flight cameras, that are arranged in an even row of the odd column or in an odd row of the even column.
(21) A computer program comprising program code causing a computer to perform the method according to any one of (11) to (20), when being carried out on a computer.
(22) A non-transitory computer-readable recording medium that stores therein a computer program product, which, when executed by a processor, causes the method according to any one of (11) to (20) to be performed.

1. A time-of-flight system comprising:
a set of time-of-flight cameras of a same type for covering a main field of view;
wherein each time-of-flight camera of the set of time-of-flight cameras includes:
an imaging unit configured to image a wide subfield of view; and
a set of illumination modules with predetermined fields of illumination;
wherein the set of illumination modules is arranged such that the fields of illumination of the set of illumination modules illuminate the wide subfield of view;
wherein the set of time-of-flight cameras is arranged such that the wide subfields of view of the set of time-of-flight cameras cover the main field of view.

2. The time-of-flight system of claim 1, wherein, for each of the set of time-of-flight cameras,
the fields of illumination of the set of illumination modules are associated with respective portions of the wide subfield of view, and
at least two of the illumination modules of the set of illumination modules are arranged with different orientations such that their fields of illumination illuminate the respective associated portions of the wide subfield of view.

3. The time-of-flight system of claim 2, wherein at least two of the time-of-flight cameras of the set of time-of-flight cameras are arranged with different orientations such that their wide subfields of view cover the main field of view.

4. The time-of-flight system of claim 3, wherein the wide subfields of view of at least two adjacent time-of-flight cameras of the set of time-of-flight cameras overlap.

5. The time-of-flight system of claim 1,
wherein, for each pair of adjacent time-of-flight cameras of the set of time-of-flight cameras, respective fields of illumination of at least one illumination module of each time-of-flight camera of the pair of adjacent time-of-flight cameras overlap.

6. The time-of-flight system of claim 5, wherein the set of illumination modules of each of the set of time-of-flight cameras is arranged in a two-dimensional array.

7. The time-of-flight system of claim 6, wherein each of the set of time-of-flight cameras is configured such that illumination modules of the set of illumination modules arranged in a first column of the two-dimensional array are drivable independently of illumination modules of the set of illumination modules arranged in a second column of the two-dimensional array.

8. The time-of-flight system of claim 6, wherein each of the set of time-of-flight cameras is configured such that illumination modules of the set of illumination modules arranged in an odd row of a first column of the two-dimensional array or in an even row of a second column of the two-dimensional array are drivable independently of illumination modules of the set of illumination modules arranged in an even row of the first column of the two-dimensional array or in an odd row of the second column of the two-dimensional array.

9. The time-of-flight system of claim 1, wherein the imaging unit of each of the set of time-of-flight cameras includes:
an image sensor configured to acquire a time-of-flight image; and
a lens configured to collect light from the wide subfield of view onto the image sensor.

10. The time-of-flight system of claim 1, wherein each of the set of illumination modules of each of the set of time-of-flight cameras is configured to emit a spot pattern into its field of illumination.

11. A method of controlling a time-of-flight system,
the time-of-flight system comprising:
a set of time-of-flight cameras of a same type for covering a main field of view;
wherein each time-of-flight camera of the set of time-of-flight cameras includes:
an imaging unit configured to image a wide subfield of view; and
a set of illumination modules with predetermined fields of illumination;
wherein the set of illumination modules is arranged such that the fields of illumination of the set of illumination modules illuminate the wide subfield of view;
wherein the set of time-of-flight cameras is arranged such that the wide subfields of view of the set of time-of-flight cameras cover the main field of view; and
the method comprising:
controlling the set of time-of-flight cameras such that the fields of illumination of the sets of illumination modules of the set of time-of-flight cameras illuminate the main field of view according to a predetermined illumination pattern.

12. The method of claim 11, wherein the predetermined illumination pattern is based on at least one of a temporal and a spatial criterion for driving the sets of illumination modules of the set of time-of-flight cameras.

13. The method of claim 11, wherein the predetermined illumination pattern represents an instruction to drive adjacent illumination modules of the sets of illumination modules of the set of time-of-flight cameras in a temporally alternating manner.

14. The method of claim 11, wherein the predetermined illumination pattern represents an instruction to illuminate a first portion of the main field of view with a first intensity and illuminate a second portion of the main field of view with a second intensity lower than the first intensity.

15. The method of claim 14, wherein the first and the second intensity differ in at least one of a power of driving corresponding illumination modules of the sets of illumination modules of the time-of-flight cameras and a density of spots emitted by the corresponding illumination modules of the sets of illumination modules of the time-of-flight cameras.

16. The method of claim 14, wherein the second portion of the main field of view includes at least one of a portion above the first portion of the main field of view in a vertical direction and a portion below the first portion of the main field of view in a vertical direction.

17. The method of claim 11, wherein the predetermined illumination pattern represents an instruction to operate the sets of illumination modules of the set of time-of-flight cameras such that an interference due to an overlap between adjacent fields of illumination is reduced.

18. The method of claim 17, wherein the predetermined illumination pattern represents an instruction to drive,
during a first time interval, illumination modules, of the sets of illumination modules of the set of time-of-flight cameras, that are arranged in a first column, and
during a second time interval, illumination modules, of the sets of illumination modules of the set of time-of-flight cameras, that are arranged in a second column adjacent to the first column.

19. The method of claim 11, wherein the predetermined illumination pattern represents an instruction to operate the sets of illumination modules of the set of time-of-flight cameras such that a heat accumulation between adjacent illumination modules of the sets of illumination modules of the set of time-of-flight cameras due to heat dissipation is reduced.

20. The method of claim 19, wherein the predetermined illumination pattern represents an instruction to drive,
during a first time interval, illumination modules, of the sets of illumination modules of the time-of-flight cameras, that are arranged in an odd row of an odd column or in an even row of an even column, and,
during a second time interval, illumination modules, of the sets of illumination modules of the time-of-flight cameras, that are arranged in an even row of the odd column or in an odd row of the even column.
